(19) United States
(12) Patent Application Publication
(10) Pub. No.: US 2019/0009709 A1
(43) Pub. Date: Jan. 10, 2019

(54) Motor Vehicle Exterior Part Comprising An Illuminating Fabric

(71) Applicant: Compagnie Plastic Omnium, Lyon (FR)

(72) Inventors: Arnaud Escoffier, Lyon (FR); Gilles Vilquin, Villeurbanne (FR)

(21) Appl. No.: 16/066,550

(22) PCT Filed: Dec. 22, 2016
(86) PCT No.: PCT/FR2016/053629

§ 371 Date: Jun. 27, 2018

(30) Foreign Application Priority Data
Dec. 30, 2015 (FR) 1563456

(51) Int. Cl. B60Q 1/26; F21V 8/00

(52) U.S. Cl. CPC B60Q 1/2615; G02B 6/0005

(57) ABSTRACT

A motor vehicle exterior part including an illuminating fabric and a support for receiving the illuminating fabric.

### FIELD OF THE INVENTION

The present invention relates to a motor vehicle exterior part and more particularly to such a part including an illuminating fabric that is intended to achieve the illuminating function of the vehicle.

### BACKGROUND OF THE INVENTION

Exterior parts including an illuminating device are provided in motor vehicles, either to improve safety, as required by law or regulation, or to contribute to the general exterior appearance of the vehicle. Here are a few nonlimiting examples: low-beam lights, position lights, brake lights, reversing lights, sidelights, overtaking lights, hazard warning lights, license-plate lights, fog lights, indicator lights, headlights, the chrome strips that run along the sides of the vehicle, protectors of rocker panels, the logo of a brand, trims of door handles, and wing-mirror covers. By extension, all the parts of the bodywork that are visible from the exterior and that have an illuminating function may fall within the field of application of the invention.

Currently, the illuminating function of parts may be achieved by means of various types of lights, in particular halogen lamps, xenon lamps, LEDs (light-emitting diodes) or OLEDs (organic light-emitting diodes), or even lasers.

With such illuminating devices during an impact, even at low speed, the optical portion is generally the first impacted and the slightest damage requires the entire optical unit to be replaced, this possibly being complicated and relatively high in cost.

### SUMMARY OF THE INVENTION

The aim of the invention is in particular to provide an alternative to existing illuminating devices, allowing the exterior part to be easily replaced in case of an impact.

To this end, one subject matter of the invention is a motor vehicle exterior part comprising an illuminating fabric and a support for receiving the illuminating fabric.

Thus, it is proposed to use an illuminating fabric to achieve an illuminating function on the exterior of the vehicle, this having a certain number of advantages. In particular, an illuminating fabric is very flexible with respect to a conventional illuminating device, so that, in case of impact, it will not be badly damaged and will remain in a perfect operating state, also being easily formable to a great variety of shapes of the exterior part. Moreover, an illuminating fabric is little bulky, with a thickness in general comprised between 0.5 mm and 1 mm. Another advantage resides in the fact that an illuminating fabric may be easily personalized by changing the colors of the light and/or of the patterns arranged on the fabric. Thus, one particularly advantageous application is in enabling easy provision, to a user, of a personalized luminous signature for his vehicle. In order to be able to use such a fabric, provision has been made for a support for receiving the illuminating fabric, which in particular positions and holds the fabric on the exterior vehicle part. This support is advantageously easily mountable on and demountable from the exterior part, and is easy and inexpensive to manufacture. Thus, the illuminating device of the exterior part allows easy repair in case of an impact. It is enough to demount the support bearing the fabric and to install as required a new fabric if the fabric was damaged and/or a new support if the support was damaged and/or a new exterior part if the exterior part was damaged, knowing that, advantageously, it is not necessary to replace the light source if the latter is located remotely, in a location that is sheltered from impacts. It should be noted that the ability to use, by virtue of the illuminating fabric, a remotely located light source is one particularly great advantage, because this allows the illuminating system, which is generally very expensive, to be placed in a zone that will not be damaged during a crash and/or that is very easily accessible. Moreover, the exterior part proposed here is not very bulky and is easily personalisable, thereby providing vehicle designers with greater design freedom.

In the present description, the expression “illuminating fabric” is generally understood to mean a collection of synthetic and/or natural fibers comprising optical fibers inserted through the stitches of the fabric. These optical fibers are generally connected to a light source, such as one or more diodes. These optical fibers may be lit from one or each of their ends, which end or ends act as a supply portion, in order to make the corresponding fabric part emit light. Such a fabric is for example described in document EP1675985. In these illuminating fabrics, the optical fibers are generally weft threads and/or warp threads, and are optionally associated with conventional fibers, for example fibers of cotton, linen or silk, or even synthetic textile fibers. An example of application of such a fabric is given in document WO 2012/098488, in which it is placed in contact with the skin of a user for an aesthetic purpose.

It will be understood that using illuminating fabric instead of conventional illuminating devices is particularly advantageous. In particular, although halogen bulbs are inexpensive and illuminate correctly, they have a relatively limited lifetime. Moreover, they consume a relatively large amount of electricity and therefore get very hot. Moreover, xenon bulbs, although they certainly have advantages over halogen bulbs, for example they last longer and deliver more powerful illuminating, they are relatively expensive because of the rarity of xenon gas. As to LEDs, they are increasingly used in vehicles, in particular because they are particularly economical in terms of power consumption and give greater freedom to designers with regard to shape. However, LEDs operate less well at high temperatures. Furthermore, another difficulty with LEDs resides in the fact that a direct use thereof may create “hotspots”, which may be disadvantageous, most particularly when designers are looking for uniformity. Lastly, although illuminating with lasers may certainly consume little energy, while providing illuminating to a great distance, their cost is so high at the moment that their use remains relatively limited.

The exterior part may furthermore include one or more of the following features, taken alone or in combination.

The illuminating fabric comprises a lit portion including optical fibers and an unlit fixing portion. The support may comprise means for assembling the illuminating fabric into the support, which cooperate with the fixing portion of the illuminating fabric. Thus, the fabric is optimized so that only the portion the function of which is to be lit is equipped with optical fibers, the fixing portion forming a technical zone that cannot be seen from the exterior.

The support comprises an interior portion and an exterior portion, the two portions being attached to each other so as to sandwich the illuminating fabric. Advantageously, the two portions are integrally formed by molding so as to form a single part. Generally, the support sandwiches the illuminating fabric by clamping, the exterior portion and the interior portion being brought closer until they are assembled together. It will be understood that the interior portion is a portion that is oriented toward the interior of the vehicle and that the exterior portion is a portion that is oriented toward the exterior of the vehicle, and more precisely towards an observer located on the exterior of the vehicle.

The exterior portion comprises a transparent zone at least partially covering a lit portion of the illuminating fabric. This zone may be made of a plastic material that is transparent to light or translucent, such as polycarbonate (PC), polymethyl methacrylate (PMMA), translucent acrylonitrile butadiene styrene (ABS) or even acrylonitrile styrene acrylate (ASA), styrene acrylonitrile (SAN), a blend of acrylonitrile styrene acrylate (ASA) and polycarbonate (PC), or even a blend of polycarbonate (PC) and polyethylene terephthalate. By virtue of this zone, the illuminating fabric is well protected and the risks of being damaged are therefore decreased.

The exterior portion comprises a frame that leaves a lit portion of the illuminating fabric at least partially uncovered. In this case, the fabric may be located in a zone that is set back with respect to the frame, so that only the frame experiences a small exterior shock, preventing damage to the fabric or scratching of a transparent zone.

The support includes assembling means including elements, such as ribs, orifices and pins, that are provided on the interior portion and the exterior portion of the support, respectively, preferably in a zone corresponding to a fixing portion of the illuminating fabric, and that cooperate with one another so as to clamp the fixing portion of the illuminating fabric. Using these assembling means, it is very easy to place the fabric between the interior portion and the exterior portion and to position the fabric in the support with a good repeatability.

The support is over molded by injection molding a material onto the illuminating fabric, the illuminating fabric preferably including orifices for the passage of injected material, or the illuminating fabric being treated to allow a good adhesion to the injected plastic material. Thus, the support and the fabric form a module that ensures a good seal tightness and that is easy to implement. The orifices for the passage of injected material that are produced in the fabric allow to improve the quality of fixation of the fabric in the interior of the support to be improved.

The support is formed by bi-injection molding an opaque first plastic material, such as polypropylene (PP) and/or polyamide (PA), and a transparent second plastic material, such as polycarbonate (PC), polymethyl methacrylate (PMMA), translucent acrylonitrile butadiene styrene (ABS) or even acrylonitrile styrene acrylate (ASA), styrene acrylonitrile (SAN), a blend of acrylonitrile styrene acrylate (ASA) and polycarbonate (PC), or even a blend of polycarbonate (PC) and polyethylene terephthalate.

The illuminating fabric is connected to a light source, for example one or more light-emitting diodes, that is located at a certain distance from the illuminating fabric in a portion of the vehicle that is sheltered from external aggressions, in particular climatic aggressions or impacts. Thus, the light source is located away from impact zones, preferably in an interior zone that is hardly exposed to exterior impacts, therefore the light source has less risk of being damaged during an impact. The zone in which the light source is placed is advantageously chosen for its available space, for its low susceptibility in the case of an impact and ideally for its seal tightness. Specifically, having the light source in a dry zone makes it possible to avoid sealing the optical unit, which may be very expensive.

The support includes, at its end, one or more slits for the passage of optical fibers with a view to connecting the optical fibers to a light source.

The support includes means for fixing the support to the exterior vehicle part, in particular by snapping, riveting, screwing, adhesive bonding or even welding.

The motor vehicle exterior part is chosen from the group comprising a front or back bumper skin, a tailgate, a front or back wing, a rocker panel, a side door, a wheel arch, a roof, and a wing-mirror cover.

The illuminating fabric forms or forms part of an illuminating device having a regulatory and/or aesthetic function, chosen from the group comprising low-beam lights, position lights, brake lights, reversing lights, sidelights, overtaking lights, hazard warning lights, license-plate lights, fog lights, indicator lights, headlights, the chrome strips that run along the sides of the vehicle, protectors of rocker panels, a logo of a brand, trims of door handles, and wing-mirror covers.

Another subject matter of the invention is a motor vehicle comprising an exterior part as presented hereinabove.

### BRIEF DESCRIPTION OF THE DRAWINGS

The invention will be better understood on reading the appended figures, which are given by way of example and are completely nonlimiting, in which figures:

FIG. 1 is a perspective view of a portion of a motor vehicle exterior part according to one embodiment.

FIG. 2 is a perspective view of an illuminating fabric of the exterior part of FIG. 1.

FIG. 3 is a perspective view of a support for receiving the illuminating fabric according to a first embodiment.

FIG. 4 is a perspective view of a support for receiving the illuminating fabric according to a second embodiment.

FIG. 5 is a perspective view of a support for receiving the illuminating fabric according to a third embodiment.

FIG. 6 is a perspective view of a support for receiving the illuminating fabric according to a fourth embodiment.

### DETAILED DESCRIPTION OF THE INVENTION

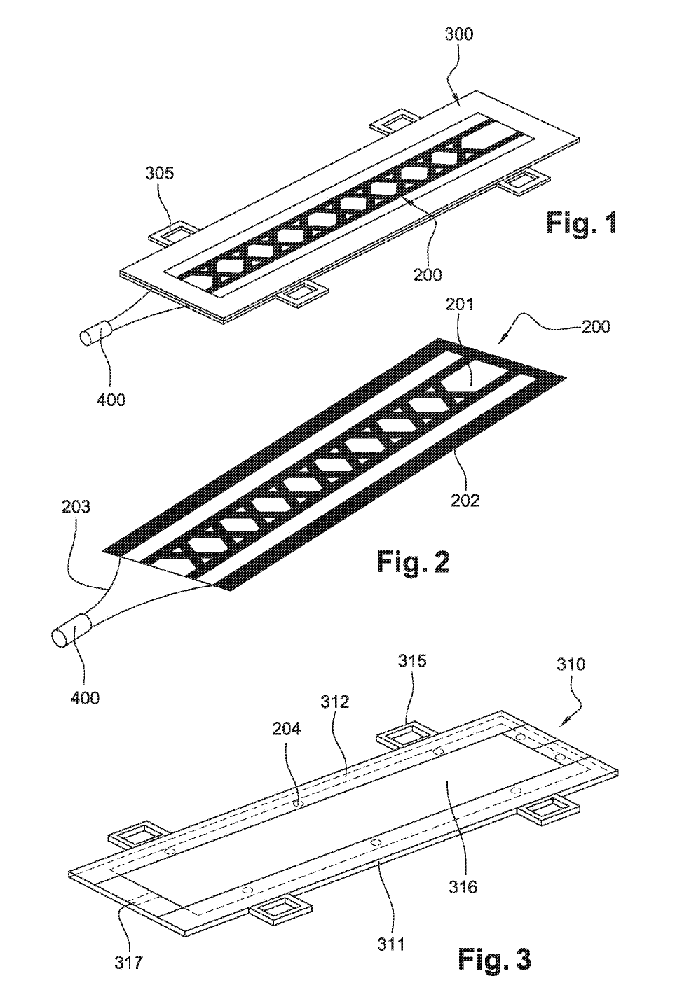

FIG. 1 illustrates in perspective a portion of a motor vehicle exterior part according to one embodiment. The exterior part may be any part located on the exterior of a vehicle that, inter alia, has an illuminating function, for example, low-beam lights, position lights, brake lights, reversing lights, sidelights, overtaking lights, hazard warning lights, license-plate lights, fog lights, indicator lights, headlights, the chrome strips that run along the sides of the vehicle, protectors of rocker panels, a logo of a brand, trims of door handles, and wing-mirror covers.

As shown in FIG. 1, the exterior part comprises an illuminating fabric 200 and a support 300 for receiving the illuminating fabric, allowing the fabric 200 to be positioned and held on the exterior vehicle part. In this embodiment, the support 300 and the fabric 200 are of planar shape. Obviously their shapes may be tailored to the exterior part on which they are mounted. In particular, in one advantageous application they have a curved shape.

The fabric 200 is positioned and held in the support 300 by means of various technologies, as described in more detail below. The support 300 is mounted on the exterior part using fixing means 305.

The fabric 200 is shown in more detail in FIG. 2. It comprises a lit portion 201 including optical fibers, and a fixing portion 202, which preferably is unlit. Preferably, the optical fibers are arranged such that the exiting light is emitted in a direction perpendicular to the plane formed by these optical fibers. The lit portion 201 of the fabric may include particular patterns such as a logo of the brand of the manufacturer or a monogram, as is shown in FIGS. 1 and 2. In this example, the fixing portion 202 of the fabric 200 is at least partially clamped in the support 300, thus allowing the fabric 200 to be positioned and held in the support 300.

The fabric 200 is connected to a light source 400, such as one or more light-emitting diodes. In the illustrated embodiment, the light source 400 is located at a certain distance from the fabric 200, advantageously in a portion of the vehicle that is sheltered from external aggressions. To this end, provision is made in the support for a slit 317, 327, 337, 347 (see FIGS. 3-6) for the passage of optical fibers 203 with a view to connecting the optical fibers 203 to the light source 400. Thus, the light source is neither exposed to impacts nor to climatic conditions and therefore has less risk of being damaged. Its lifetime may thus be increased.

Four embodiments of the support will now be described with reference to FIGS. 3 to 6, respectively.

According to a first embodiment, illustrated in FIG. 3, the support 310 comprises an interior portion 311 and an exterior portion 312, the two portions being integrally formed. In this embodiment, the support 310 is over molded by injection molding a material, preferably a thermoplastic, onto the fabric (indicated by dashed lines in FIG. 3). In order to improve the quality with which the fabric and the support are fixed together, the fabric may include orifices 204 for the passage of injected material, preferably in the fixing portion 202.

The exterior portion 312 of the support 310 includes a zone 316 that leaves the lit portion 201 of the fabric 200 at least partially uncovered. This zone may be a single aperture. In other words, the exterior portion 312 may include a frame the aperture of which forms the zone 316. According to one variant, this zone may be covered with a layer made of a plastic material that is transparent to light or translucent, in order to protect the fabric. In this case, it is advantageous to form the support by bi-injection molding an opaque first plastic material, such as polypropylene (PP) and/or polyamide (PA), which will form the interior portion 311, and a zone of the exterior portion 312 forming a frame around the protective layer covering the zone 316; and a transparent second plastic material, such as polycarbonate (PC), polymethyl methacrylate (PMMA), translucent acrylonitrile butadiene styrene (ABS) or even acrylonitrile styrene acrylate (ASA), styrene acrylonitrile (SAN), a blend of acrylonitrile styrene acrylate (ASA) and polycarbonate (PC), or even a blend of polycarbonate (PC) and polyethylene terephthalate, which will form the protective layer of the exterior portion 312. By virtue of the protective layer, the illuminating fabric is well protected, and the risks of it being damaged are therefore decreased.

As mentioned above, the support 310 comprises a slit 317 for the passage of optical fibers 203 with a view to connecting the optical fibers 203 to the light source 400. This slit 317 is created naturally during the over molding because of the presence of the fibers 203.

Lastly, the support 310 includes means 315 for fixing the support to the exterior vehicle part, which means take the form of snapping apertures that are 4 in number here, and that cooperate with snapping elements arranged on the exterior part so as to fix the support 310 to the latter. The fixing means may take other forms, for example riveting means, screwing means, adhesive-bonding means or even welding means.

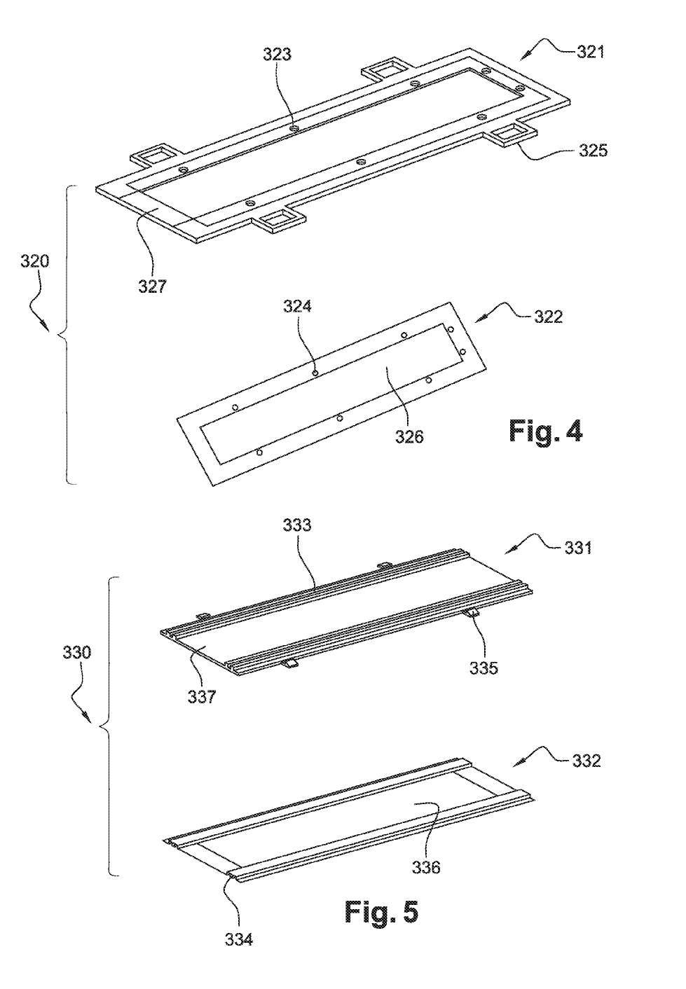

According to a second embodiment, illustrated in FIG. 4, the support 320 comprises an interior portion 321 and an exterior portion 322, the two portions being attached to each other, so as to sandwich the illuminating fabric 200. To do this, the support 320 includes assembling means that are provided on its interior portion 321 and on its exterior portion 322, respectively, and that cooperate with each other so as to clamp the fixing portion 202 of the fabric 200. Preferably, these assembling means are provided in a zone corresponding to the fixing portion 202 of the fabric 200. In this embodiment, the assembling means include orifices 323 produced in the interior portion 321 and pins 324 produced in the exterior portion 322, which cooperate with one another so as to clamp the fabric 200, which is provided with corresponding orifices. Naturally, provision may be made to provide orifices in the exterior portion 322 and pins in the interior portion 321.

As was seen in the first embodiment, the exterior portion 322 of the support 320 also includes a zone 326 that leaves the lit portion 201 of the fabric 200 at least partially uncovered. The features associated with this zone are identical to those described with regard to the first embodiment and will therefore not be described again here, and likewise for the slit 327 for the passage of optical fibers and for the means 325 for fixing the support to the exterior part.

According to a third embodiment, which is similar to the second and illustrated in FIG. 5, the support 330 comprises an interior portion 331 and an exterior portion 332, the two portions being attached to each other so as to sandwich the illuminating fabric 200. To do this, the support 330 includes assembling means that are provided on its interior portion 331 and its exterior portion 332, respectively, and that cooperate with each other so as to clamp the fixing portion 202 of the fabric 200. Preferably, these assembling means are provided in a zone corresponding to the fixing portion 202 of the fabric 200. In this embodiment, the assembling means include ribs 333 that are provided on the interior portion 331 and ribs 334 that are provided on the exterior portion 332, which cooperate with one another so as to clamp the fabric 200. Preferably, the ribs extend over the entire length of the support, thus ensuring a better retention of the fabric in the support.

As was seen in the first embodiment, the exterior portion 332 of the support 330 also includes a zone 336 that leaves the lit portion 201 of the fabric 200 at least partially uncovered. The features associated with this zone are identical to those described with regard to the first embodiment and will therefore not be described again here, and likewise for the slit 337 for the passage of optical fibers. In this embodiment, means 335 for fixing the support to the exterior part taking the form of snapping protuberances are illustrated.

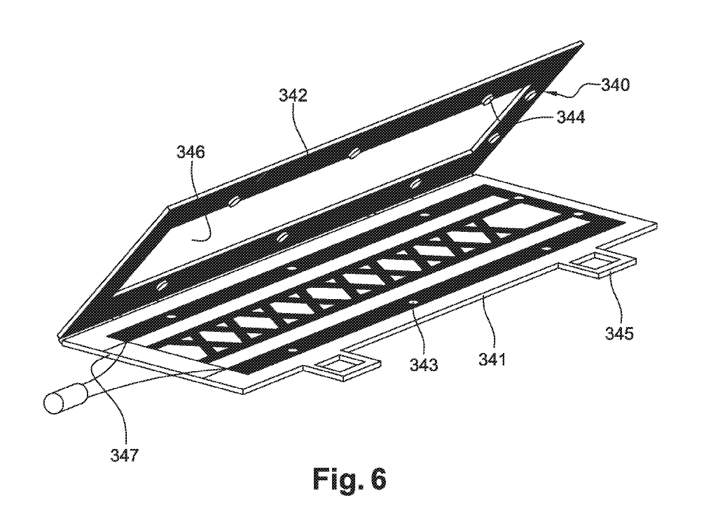

According to a fourth embodiment, which is similar to the second and illustrated in FIG. 6, the support 340 comprises an interior portion 341 and an exterior portion 342, the two portions forming a single inseparable part. More precisely, the portions 341 and 342 are integrally molded along one of their longitudinal edges, the opposite sides of each of the portions 341 and 342 being attached to each other by folding them about this longitudinal edge, so that the support closes and sandwiches the illuminating fabric 200. The support 340 includes assembling means that are provided on its interior portion 341 and its exterior portion 342, respectively, and that cooperate with each other so as to clamp the fabric 200. Preferably, these assembling means are provided in a zone corresponding to the fixing portion 202 of the fabric 200. In this embodiment, the assembling means include orifices 343 that are provided in the interior portion 341 and pins 344 that are produced on the exterior portion 342, which cooperate with one another so as to clamp the fabric 200, which is provided with corresponding orifices. Naturally, provision may be made for orifices in the exterior portion 342 and pins on the interior portion 341.

As was seen in the first embodiment, the exterior portion 342 of the support 340 also includes a zone 346 that leaves the lit portion 201 of the fabric 200 at least partially uncovered. The features associated with this zone are identical to those described with regard to the first embodiment and will therefore not be described again here, and likewise for the slit 347 for the passage of optical fibers and for the means 345 for fixing the support to the exterior part.

Although several embodiments of the invention have been described here, the invention is obviously in no way limited by these embodiments, and various modifications and changes may be made thereto without however departing either from its scope or its spirit.

1. A motor vehicle exterior part comprising an illuminating fabric and a support for receiving the illuminating fabric, wherein the illuminating fabric comprises a lit portion including optical fibers and an unlit fixing portion, the support comprising an element which assembles the illuminating fabric into the support, which element cooperates with the fixing portion of the illuminating fabric.

2. The exterior part according to claim 1, wherein the support comprises an interior portion and an exterior portion, the two portions being attached to each other or integrally formed so as to sandwich the illuminating fabric.

3. The exterior part according to claim 1, wherein the exterior portion comprises a transparent zone at least partially covering a lit portion of the illuminating fabric.

4. The exterior part according to claim 2, wherein the exterior portion comprises a frame that leaves the lit portion of the illuminating fabric at least partially uncovered.

5. The exterior part according to claim 2, wherein the element of the support is selected from the group consisting of ribs, orifices and pins, that are provided on the interior portion and the exterior portion of the support, respectively, in a zone corresponding to the unlit fixing portion of the illuminating fabric, and that cooperate with one another so as to clamp the unlit fixing portion of the illuminating fabric.

6. The exterior part according to claim 1, wherein the support is over molded by injection molding material onto the illuminating fabric, the illuminating fabric including orifices for the passage of the injection molding material, or the illuminating fabric being treated to allow a adhesion to the injection molding material.

7. The exterior part according to claim 1, wherein the support is formed by bi-injection molding an opaque first plastic material, and a transparent second plastic material.

8. The exterior part according to claim 1, wherein the illuminating fabric is connected to a light source that is located at a certain distance from the illuminating fabric, in a portion of the vehicle that is sheltered from external aggressions.

9. The exterior part according to claim 1, wherein the support includes, at an end of the support, one or more slits for passage of optical fibers with a view to connecting the optical fibers to a light source.

10. The exterior part according to claim 1, wherein the support includes a fixing device for fixing the support to the motor vehicle exterior part.

11. The exterior part according to claim 7 wherein the opaque first plastic material is as polypropylene and/or polyamide.

12. The exterior part according to claim 7 wherein the transparent second plastic material is selected from the group consisting of polycarbonate, polymethyl methacrylate, translucent acrylonitrile butadiene styrene, acrylonitrile styrene acrylate, styrene acrylonitrile, a blend of acrylonitrile styrene acrylate and polycarbonate, a blend of polycarbonate and polyethylene terephthalate, and combinations thereof.

13. The exterior part according to claim 8 wherein the light source is a light-emitting diode.

14. The exterior part according to claim 10 wherein the fixing device fixes the support to the motor vehicle exterior part by snapping, riveting, screwing, adhesive bonding or welding.
